(19) United States
(12) Patent Application Publication
(10) Pub. No.: US 2018/0220053 A1
(43) Pub. Date: Aug. 2, 2018

(54) PROCESSING DEVICE, PROCESSING METHOD, SYSTEM, AND ARTICLE MANUFACTURING METHOD

(71) Applicant: CANON KABUSHIKI KAISHA, Tokyo (JP)

(72) Inventor: Hiroshi Yoshikawa, Kawasaki-shi (JP)

(21) Appl. No.: 15/875,190

(22) Filed: Jan. 19, 2018

(30) Foreign Application Priority Data
Feb. 2, 2017 (JP) 2017-017601

(51) Int. Cl. H04N 5/238; H04N 5/232

(52) U.S. Cl. CPC H04N 5/238; H04N 5/23216; H04N 5/23222; H04N 5/23212

(57) ABSTRACT

A processing device including an imaging unit for obtaining image data by imaging an object and a control unit for controlling the imaging unit, wherein the control unit configured to determine a condition for the imaging on the basis of a magnitude of a luminance distribution corresponding to the image data.

### BACKGROUND OF THE INVENTION

### Field of the Invention

The present invention relates to a processing device, a processing method, a system, and an article manufacturing method.

### Description of the Related Art

A method of measuring a distance by projecting pattern light onto an object using a projection unit such as a projector and specifying a position of the pattern light from image data obtained by imaging the object using an imaging unit such as a camera is known. A luminance value of the pattern light in the image data can be too high or too low due to conditions of the object such as reflectivity of a surface of the object and a posture of the object, and thereby it can be difficult to specify a position of the pattern light with high accuracy. In order to specify a position of the pattern light with high accuracy regardless of the conditions of the object, it is necessary to appropriately adjust at least one of illuminance of the pattern light on a surface of the object and an exposure amount in the imaging unit.

There is a method of measuring a three-dimensional shape in which a difference between a peak value of the luminance of projected light and a peak value of the luminance of background light in image data is adjusted by adjusting an exposure amount of an imaging unit and an optical cutting line is extracted (Japanese Patent Laid-Open No. 2009-250844). In addition, there is a method of improving recognizability of details of image data by adjusting a proportion of pixels having luminance equal to or greater than a high luminance threshold value and a proportion of pixels having luminance equal to or less than a low luminance threshold value in the image data under exposure amount control (Japanese Patent No. 4304610).

However, since it is difficult to clearly separate between projected light and background light in a measurement method by pattern light projection, the method of Japanese Patent Laid-Open No. 2009-250844 is difficult to apply. In addition, adjustment of a luminance value in image data cannot be regarded to be sufficient without considering a luminance distribution of medium luminance pixels between the high luminance threshold value and the low luminance threshold value in the method of Japanese Patent No. 4304610.

### SUMMARY OF THE INVENTION

The present invention provides, for example, a processing device which is advantageous in terms of measurement accuracy and obtains a luminance value distribution in image data.

In a processing device of the present invention, which includes an imaging unit for obtaining image data by imaging an object and a control unit for controlling the imaging unit, the control unit determines a condition for imaging on the basis of a magnitude of a luminance distribution corresponding to the image data.

Further features of the present invention will become apparent from the following description of exemplary embodiments with reference to the attached drawings.

### BRIEF DESCRIPTION OF THE DRAWINGS

FIG. 1 is a schematic diagram which shows a configuration of a processing device according to a first embodiment.

FIGS. 2A to 2C are histograms which represent a luminance value distribution of pixels constituting a captured image according to three different measurement conditions for an object whose diffuse reflectivity is higher than the specular reflectivity.

FIG. 3 is a diagram which shows a graph for obtaining an optimum measurement condition for the object whose diffuse reflectivity is higher than the specular reflectivity on the basis of a captured image in a plurality of measurement conditions.

FIGS. 4A to 4C are histograms which represent a luminance value distribution of pixels constituting a captured image according to three different measurement conditions for an object whose specular reflectivity is higher than the diffuse reflectivity.

FIG. 5 is a diagram which shows a graph for obtaining an optimum measurement condition for the object whose specular reflectivity is higher than the diffuse reflectivity on the basis of a captured image in a plurality of measurement conditions.

FIG. 6 is a flowchart which shows a process of determining an optimum measurement condition.

FIG. 7 is a flowchart which shows a process of determining an optimum measurement condition according to a second embodiment.

FIG. 8 is a diagram which shows a control system including a gripping device equipped with a processing device.

FIG. 9 is a diagram which shows an example of information displayed on a display unit.

FIGS. 10A to 10E are diagrams which show various types of images displayed in an image display region.

### DESCRIPTION OF THE EMBODIMENTS

### First Embodiment

Hereinafter, embodiments for realizing the present invention will be described with reference to the drawings.

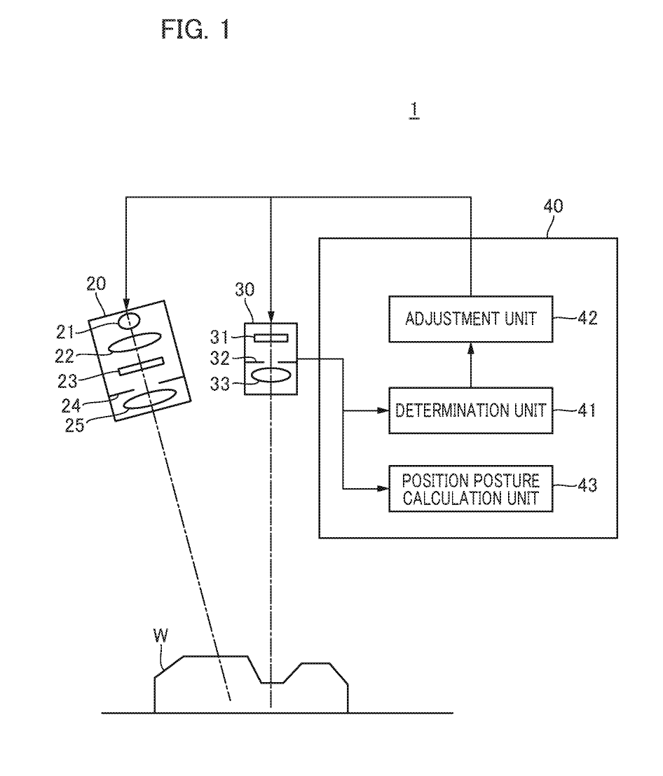

FIG. 1 is a schematic diagram which shows a configuration of a processing device 1 according to a first embodiment. The processing device 1 measures a shape of an object W and obtains a position and a posture of the object W on the basis of a result of the measurement. The processing device 1 includes a measurement head including a projection unit 20 and an imaging unit 30, and a control unit 40. The projection unit 20 projects light onto the object W. The imaging unit 30 images the object W onto which light is projected. The control unit 40 is a control circuit including, for example, a CPU, a memory, and the like, measures a two-dimensional shape and a three-dimensional shape of the object W from a captured image captured by the imaging unit 30, and obtains a position and a posture of the object W using a result of the measurement and a CAD model of the object W. In addition, the control unit 40 adjusts an illuminance of the light projected onto the object W by the projection unit 20 and adjusts an exposure amount of the imaging unit 30.

The projection unit 20 includes a light source 21, an illumination optical system 22, a display element 23, a projection diaphragm 24, and a projection optical system 25. As the light source 21, various types of light emitting elements such as a halogen lamp and an LED are used. The illumination optical system 22 is an optical system having functions of making a uniform light intensity of light emitted from the light source 21 and guiding it to the display element 23, and an optical system such as a Koehler illumination, a diffuse plate, or the like is used.

The display element 23 is an element having a function of spatially controlling the transmittance or reflectivity of light from the illumination optical system 22 in accordance with a predetermined pattern of the light projected onto the object W. For example, a transmissive liquid crystal display (LCD), a reflective liquid crystal on silicon (LCOS), a digital micro-mirror device (DMD), and the like are used. The predetermined pattern is generated by the control unit 40 and output to the display element 23. In addition, the pattern may be generated by a device different from the control unit 40 and may also be generated by a device not shown in the projection unit 20.

The projection diaphragm 24 is used to control an F value of the projection optical system 25. As the F value is small, a light amount of light passing through a lens in the projection optical system 25 increases. The projection optical system 25 is an optical system which is configured to image light guided from the display element 23 at a specific position of the object W.

The imaging unit 30 includes an imaging element 31, an imaging diaphragm 32, and an imaging optical system 33. As the imaging element 31, various types of photoelectric conversion elements such as a CMOS sensor and a CCD sensor are used. An analog signal photo-electrically converted using the imaging element 31 is converted into a digital image signal by a device not shown in the imaging unit 30. The device generates an image (captured image) constituted of pixels having a luminance value based on a digital image signal, and outputs the generated captured image to the control unit 40. The imaging diaphragm 32 is used to control an F value of the imaging optical system 33. The imaging optical system 33 is an optical system configured to image a specific position of the object W on the imaging element 31.

The imaging unit 30 captures the object W every time a pattern of the light projected onto the object W from the projection unit 20 is changed, and acquires a captured image for light in each of a plurality of patterns. The control unit 40 causes the imaging unit 30 and the projection unit 20 to operate in synchronization with each other.

The control unit 40 includes a determination unit 41, an adjustment unit 42, and a position posture calculation unit 43. The determination unit 41 determines measurement conditions (referred to as an imaging conditions) including the exposure amount of the imaging unit 30 at the time of measuring the object W and the illuminance of the light projected by the projection unit 20 on the basis of a spread magnitude of the luminance value distribution of pixels constituting a captured image acquired by the imaging unit 30. Here, the spread magnitude indicates a spread of the magnitude of the luminance value distribution such as size, largeness, area and dimension. The adjustment unit 42 adjusts at least one of the projection unit 20 and the imaging unit 30 so that a spread magnitude of the luminance value distribution is within an allowable range on the basis of the measurement conditions determined by the determination unit 41.

The exposure amount of the imaging unit 30 is adjusted by adjusting at least one of an exposure time (referred to as a shutter speed) under control of the imaging element 31 and an F value of the imaging optical system 33. The luminance value of each pixel constituting a captured image increases as the exposure time is extended. In addition, as the F value decreases, the luminance value of each pixel increases. Since a depth of field of the imaging optical system 33 changes by control of the imaging diaphragm 32, the imaging diaphragm 32 is controlled in consideration of an amount of the change.

The illuminance of the light projected onto the object W by the projection unit 20 is adjusted by adjusting any one of an emission luminance of the light source 21, a display gradation value of the display element 23, and an F value of the projection optical system 25. If a halogen lamp is used as the light source 21, as an applied voltage increases, the emission luminance increases and the illuminance increases. If an LED is used as the light source 21, as a current flowing in the LED increases, the emission luminance increases and the illuminance increases.

If the transmissive LCD is used as the display element 23, as the display gradation value increases, the transmittance increases and the illuminance increases. If the reflective LCOS is used as the display element 23, as the display gradation value increases, the reflectivity increases and the illuminance increases. If the DMD is used as the display element 23, as the display gradation value increases, the number of times of ON per frame increases and the illuminance increases.

As the F value decreases, the illuminance of the light projected onto the object W increases. Since the depth of field of the projection optical system 25 changes by control of the projection diaphragm 24, the projection diaphragm 24 is controlled in consideration of an amount of the change.

The position posture calculation unit 43 calculates a three-dimensional shape of the object W from a distance image captured by the imaging unit 30. The distance image is obtained by imaging the object W onto which light is projected in a line pattern in which a bright portion formed of bright lines and a dark portion formed of dark lines are alternately and periodically arranged. In addition, the position posture calculation unit 43 calculates a two-dimensional shape of the object W from a grayscale image captured by the imaging unit 30. The grayscale image is obtained by imaging the object W which is uniformly illuminated. The three-dimensional shape is obtained, for example, by calculating a distance from the imaging unit 30 to the object W using a space coding method. The position posture calculation unit 43 obtains a position and a posture of the object W using the three-dimensional shape and a CAD model of the object W.

In the space coding method used in the present embodiment, first, a waveform consisting of the luminance values of pixels constituting a captured image of the object W onto which light is projected in a line pattern (hereinafter referred to as positive pattern light) including a bright portion and a dark portion is obtained. Next, a waveform consisting of the luminance values of pixels constituting a captured image of the object W onto which light is projected in a line pattern (hereinafter referred to as negative pattern light) in which the bright portion and the dark portion in the line pattern light are inverted is obtained. A plurality of intersection positions between the two obtained waveforms are regarded as positions of the line pattern light. In addition, in the positive pattern, a spatial code “1” is given to the bright portion and a spatial code “0” is given to the dark portion. The same processing is performed while a width of the line pattern light is changed. It is possible to determine an emission direction (projection direction) of the line pattern light from the projection unit 20 by combining and decoding spatial codes with different widths of light. A distance from the imaging unit 30 to the object W is calculated on the basis of this emission direction and the position of the line pattern light.

The determination unit 41 determines a measurement condition including illuminance of light and an exposure amount so that luminance values in the plurality of intersection positions between the two waveforms fall within a predetermined range. If a luminance value at an intersection position is calculated based on luminance values in the vicinity of the intersection position, it is desirable to determine a measurement condition so that the highest luminance value among the luminance values in the vicinity of the intersection position falls within the predetermined range. If a two-dimensional shape is calculated using a grayscale image, for example, a measurement condition is determined so that luminance values of the entire grayscale image fall within the predetermined range. Cases in which the luminance values are outside of the predetermined range include, for example, a case in which luminance of intersection positions is too low and blackened and a case in which the luminance is too high and saturated.

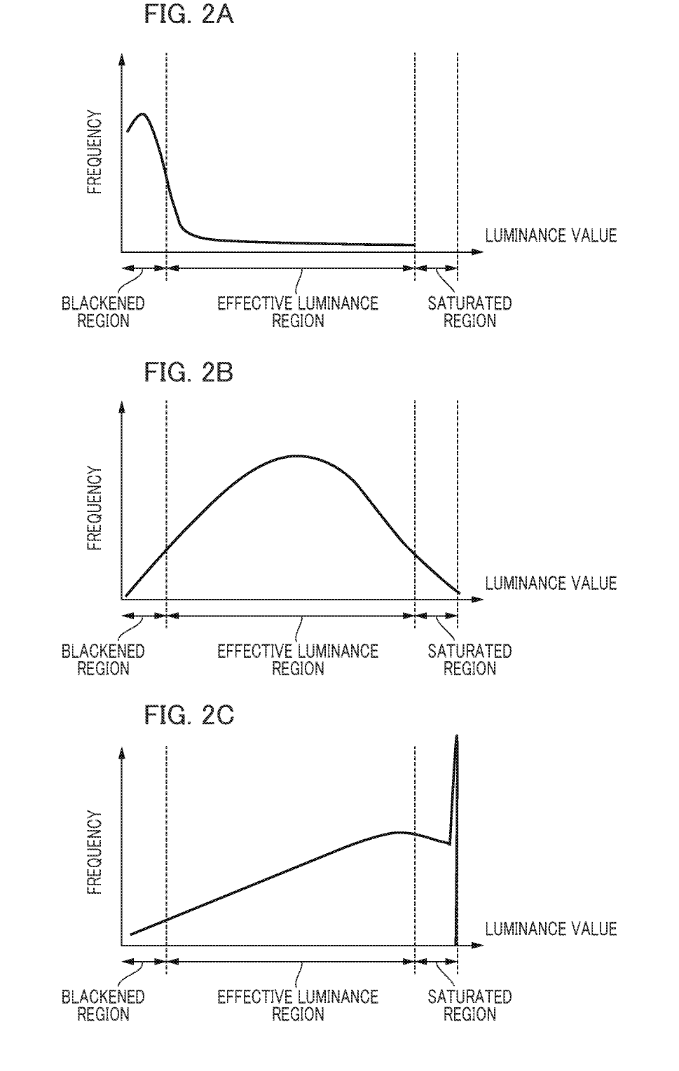

FIGS. 2A to 2C are histograms which represent a luminance value distribution of pixels constituting a captured image acquired by the imaging unit 30 according to three different measurement conditions for an object W whose diffuse reflectivity is higher than the specular reflectivity. The horizontal axis represents a luminance value and the vertical axis represents a frequency (referred to as a frequency) of a pixel belonging to a section (referred to as a bin) in which a luminance value is divided by a predetermined width. In the horizontal axis, a region in which a pixel with a low luminance is blackened is set as a blackened region and a region whose luminance is high enough to be saturated is set as a saturated region. A region interposed between the blackened region and the saturated region is set as an effective predetermined luminance value range (referred to as an effective luminance region) for specifying a position of a pattern light. It is preferable to set around the lowest 2% of an image luminance range as the blackened region. In the same manner, it is preferable to set around the highest 2% of the image luminance range as the saturated region. In a description of an image of 8 bit gradations (255 gradations) as an example, the lowest 2% ranges from 0 to 5 in luminance gradation and the highest 2% ranges from 250 to 255 in luminance gradation.

FIG. 2A is a histogram in a measurement condition in which the exposure amount of the imaging unit 30 or the illuminance of the light projected onto the object W is low. In this case, a luminance distribution of pixels is biased to a low luminance side. FIG. 2B is a histogram in a measurement condition in which the exposure amount of the imaging unit 30 or the illuminance of the light projected onto the object W is adjusted to improve accuracy in specifying a position of pattern light. In this case, a luminance distribution of pixels has a peak of distribution in the vicinity of a center of the effective luminance region. FIG. 2C is a histogram in a measurement condition in which the exposure amount of the imaging unit 30 or the illuminance of the light projected onto the object W is high. In this case, a luminance distribution of pixels is biased to a high luminance side.

In order to improve the accuracy in specifying a position of pattern light, the luminance distribution needs to spread over an entirety of the effective luminance region. Furthermore, if the number of pixels included in the effective luminance region is increased as much as possible, it is possible to improve the accuracy. As an evaluation criterion of the luminance value distribution, a standard deviation of the luminance value distribution and other evaluation criteria can also be applied. Here, three other evaluation criteria are exemplified.

The first evaluation criterion is the number of bins whose frequencies are equal to or greater than a predetermined value (for example, more than one fourth of a frequency maximum value) among bins included in the effective luminance region. As the number of bins increases, it is possible to evaluate that the luminance value distribution spreads to the entirety of the effective luminance region (the spread of the luminance value distribution is large, the bias of the luminance value distribution is small, and the uniformity (flatness) of the luminance value histogram is high).

The second evaluation criterion is the number of bins whose frequencies are included in a predetermined range among the bins included in the effective luminance range. In the same manner as the first evaluation criterion, as the number of bins increases, it is possible to evaluate that the spread of the luminance value distribution is large. The third evaluation criterion is an entropy value in the case in which a luminance histogram of a two-dimensional image is regarded as a probability distribution. Entropy is a statistical measure of randomness and is defined by −Σp·log₂(p). Here, p is a frequency of the luminance value histogram normalized so that a sum is one. As the entropy increases, the spread of the luminance value distribution can be evaluated to be large.

The number of pixels included in the effective luminance region can be evaluated, for example, on the basis of a proportion of pixels included in the effective luminance region among all pixels constituting a captured image. That is, a value obtained by dividing a result of subtracting the number of pixels included in the blackened region and the number of pixels included in the saturated region from the total number of pixels by the total number of pixels is the proportion of pixels included in the effective luminance region.

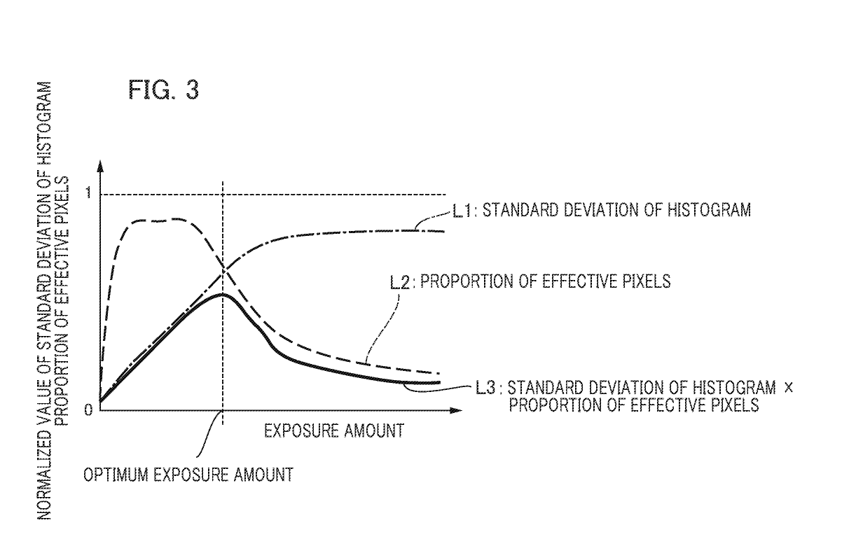

FIG. 3 is a diagram which shows a graph for obtaining an optimum measurement condition on the basis of a captured image in a plurality of measurement conditions. The plurality of measurement conditions in FIG. 3 are set to have constant illuminance of the light projected onto the object W and a change only in the exposure amount of the imaging unit 30. A horizontal axis of the graph shown in FIG. 3 represents the exposure amount. A curved line L1 in the graph of FIG. 3 represents a change in standard deviation of the normalized luminance distribution. Normalization is performed as follows. First, a standard deviation of the luminance value distribution of pixels in each of a plurality of captured images is obtained. Among a plurality of obtained standard deviations, a standard deviation corresponding to each of the plurality of captured images is normalized by dividing each standard deviation by a maximum standard deviation.

The curved line L1 may also be obtained by normalizing the number of bins whose frequencies are equal to or greater than a predetermined value among the bins included in the effective luminance region, the number of bins whose frequencies are included in a predetermined range among the bins included in the effective luminance region, the entropy (described above) of the luminance value histogram, and the like. In addition, the curved line L2 represents a change in the proportion of pixels included in the effective luminance region, which corresponds to each of the plurality of captured images.

If the optimum measurement condition is obtained only from the curved line L1, an exposure amount at which the curved line L1 has a maximum value is the optimum measurement condition. Furthermore, if the optimum measurement condition is obtained in consideration of the curved line L2, an exposure amount at which the curved line L3 (for example, L1×L2) obtained by combining the curved line L1 and the curved line L2 is a maximum value is the optimum measurement condition.

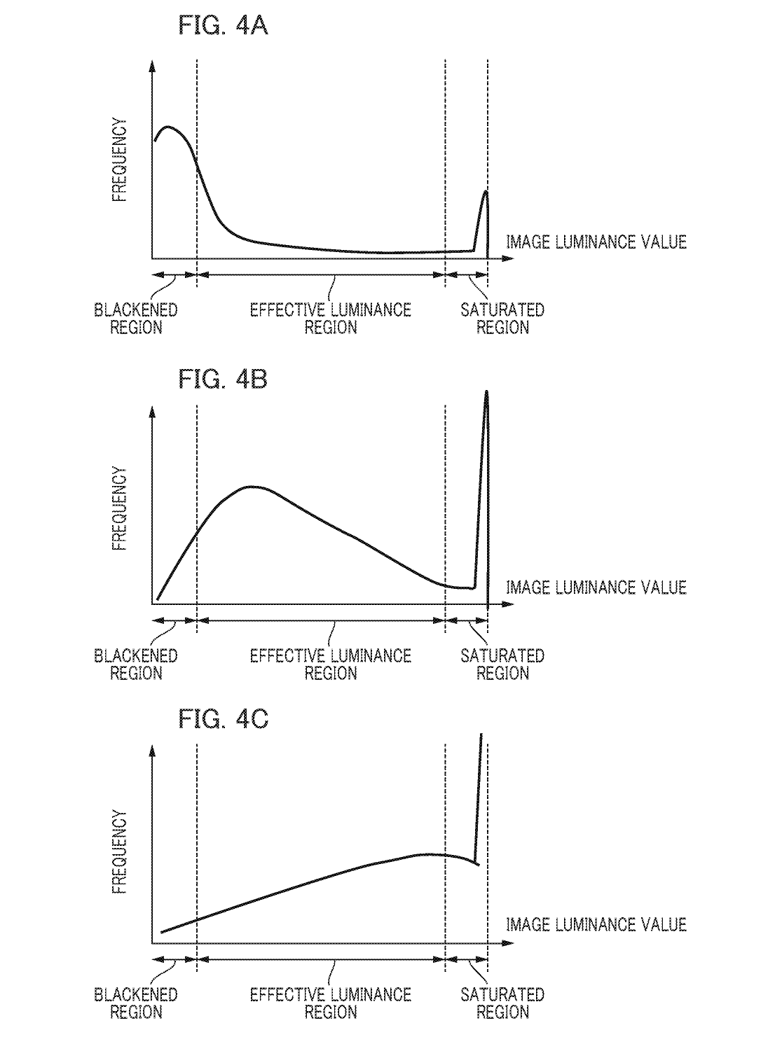

FIGS. 4A to 4C are histograms which represent a luminance value distribution of pixels constituting a captured image acquired by the imaging unit 30 according to three different measurement conditions for the object W whose specular reflectivity is higher than the diffuse reflectivity. Definitions of axes and regions are the same as in FIG. 2. FIG. 4A is a histogram in a measurement condition in which the exposure amount of the imaging unit 30 or the illuminance of the light projected onto the object W is low. In the case of the object W with high specular reflectivity, if a specular reflection condition is set up, the luminance of pixels is extremely high. As a result, there may be pixels in the saturated region even in a low exposure amount state or a low illuminance state.

FIG. 4B is a histogram in a measurement condition in which the exposure amount of the imaging unit 30 or the illuminance of the light projected onto the object W is adjusted to improve the accuracy in specifying a position of pattern light. The frequencies of pixels in the saturated region are large as compared with FIG. 2B in which diffuse reflectivity is high, but the spread of the distribution and the number of pixels in the effective luminance region are improved as compared with FIG. 4A. FIG. 4C is a histogram in a measurement condition in which the exposure amount of the imaging unit 30 or the illuminance of the light projected onto the object W is high. In this case, the luminance distribution of pixels is biased to a high luminance side. In the case of the object W with high specular reflectivity, since there is a large difference between luminance and darkness caused by an inclination of the object W, there are many regions that are not easily saturated even if the exposure amount is increased. For this reason, in the case of the object with high diffuse reflectivity, even if the number of pixels in the saturated region is not drastically increased, the number of pixels belonging to the effective luminance region is less than in FIG. 4B.

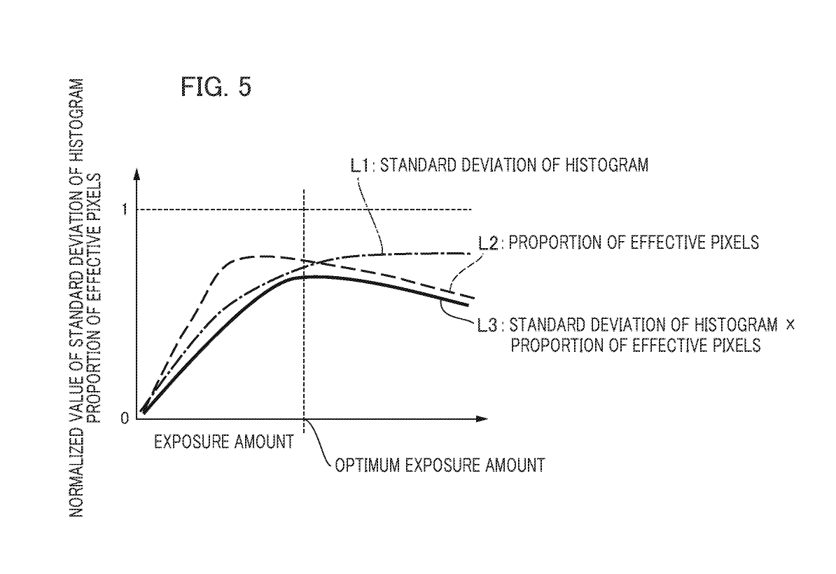

FIG. 5 is a diagram which shows a graph for obtaining an optimum measurement condition on the basis of a captured image in a plurality of measurement conditions. In the same manner as in FIG. 3, the plurality of measurement conditions are set to have a change only in the exposure amount. Definitions of axes and curved lines are the same as in FIG. 3. Compared with FIG. 3 in which the diffuse reflectivity is higher than the specular reflectivity, it is possible to obtain an optimum exposure time of a slowing peak of the curved line L3. The peak is slowed because the object W with high specular reflectivity has a lower increase amount in proportion of saturated pixels when the exposure amount is increased.

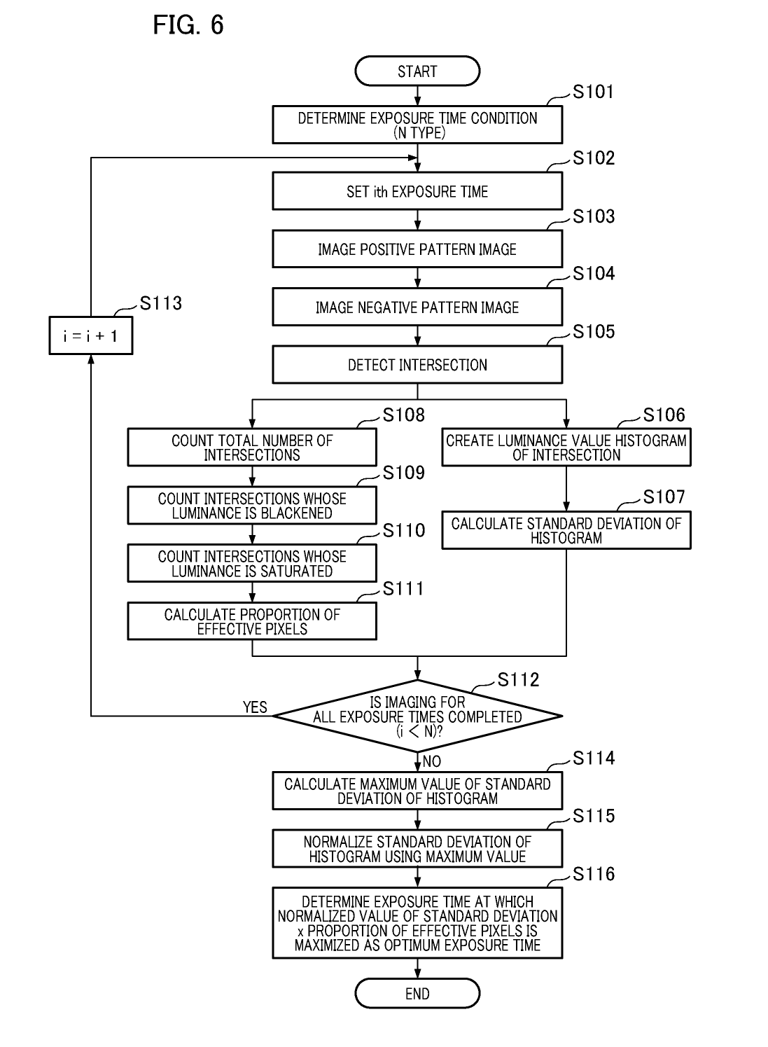

FIG. 6 is a flowchart which shows a process of determining an optimum measurement condition. Each process is performed by the determination unit 41 or the adjustment unit 42 in the control unit 40. In addition, a case in which a three-dimensional shape is obtained by the space coding method described above will be described. In the above description, a measurement condition is determined on the basis of the luminance value of pixels and the number of pixels. However, in the case in which the space coding method is used, a measurement condition is determined on the basis of the luminance value of intersections and the number of intersections. In the present embodiment, an optimum exposure time is determined by changing only an exposure time among measurement conditions. In a process of S101, the determination unit 41 determines N types of a plurality of exposure times for performing imaging. In a process of S102, the determination unit 41 sets an i^{th} exposure time. For a first time, i is set to one. In a process of S103 and a process of S104, the adjustment unit 42 adjusts the projection unit 20 and the imaging unit 30 on the basis of a measurement condition including the exposure time set by the determination unit 41. In the process of S103, the object W onto which positive pattern light is projected is imaged. For the projected pattern light, only one type of pattern light with the narrowest line pattern may be used. In a process of S104, the object W onto which negative pattern light is projected is imaged. Like the positive pattern light, only one type of pattern light with the narrowest line pattern may be used. The process of S103 and the process of S104 are not in a particular order.

In a process of S105, the determination unit 41 obtains a plurality of intersections between a luminance value distribution of pixels constituting a captured image captured in the process of S103 and a luminance value distribution of pixels constituting a captured image captured in the process of S104. A process of S106 and a process of S107 are flows for obtaining the curved line L1 described above, and a process of S108 to a process of S111 are flows for obtaining the curved line L2 described above. These flows may progress in parallel and may also progress separately and sequentially.

In the process of S106, the determination unit 41 classifies the plurality of intersections obtained in the process of S105 into respective sections of the luminance value histogram on the basis of luminance values of the plurality of intersections. In a process of S107, the determination unit 41 calculates a standard deviation of the histogram.

In a process of S108, the determination unit 41 counts a total number of the plurality of intersections obtained in the process of S105. In a process of S109, the determination unit 41 counts the number of intersections included in the blackened region. In a process of S110, the determination unit 41 counts a total number of intersections included in the saturated region. In a process of S111, the determination unit 41 calculates a proportion of intersections included in the effective luminance region by dividing a result of subtracting the number of intersections included in the blackened region and the number of intersections included in the saturated region from the total number of intersections by the total number of intersections.

In a process of S112, the determination unit 41 determines whether imaging for N types of exposure times determined in the process of S101 has been completed (i<N). If it is determined that imaging has not been completed, one is added to i in a process of S113 and a next exposure time is set in the process of S102. If it is determined that imaging has been completed (i=N), in a process of S114, the determination unit 41 obtains a maximum value of the standard deviation obtained in the process of S107. In a process of S115, the determination unit 41 normalizes the standard deviation obtained in the process of S107 using the maximum value obtained in the process of S114. In a process of S117, the determination unit 41 performs multiplication of the proportion obtained in the process of S111 and the normalized value of the standard deviation obtained in the process of S115 and sets an exposure time at which a result of the multiplication is a maximum value to an optimum exposure time.

As described above, the processing device 1 of the present embodiment can determine an appropriate measurement condition regardless of reflectivity of the surface of the object W. As a result, according to the present embodiment, it is possible to provide a processing device which obtains a luminance value distribution in image data, which is advantageous in terms of measurement accuracy.

### Second Embodiment

In the first embodiment, a case of measuring a position of line pattern light in calculation of a three-dimensional shape using a space coding method was mainly described. In the present embodiment, a case of calculating a two-dimensional shape using a grayscale image obtained by projecting uniform light onto the object W will be described. The present embodiment is different from the first embodiment in that pixels constituting one captured image instead of two luminance distribution intersections corresponding to two captured images are used to determine a measurement condition.

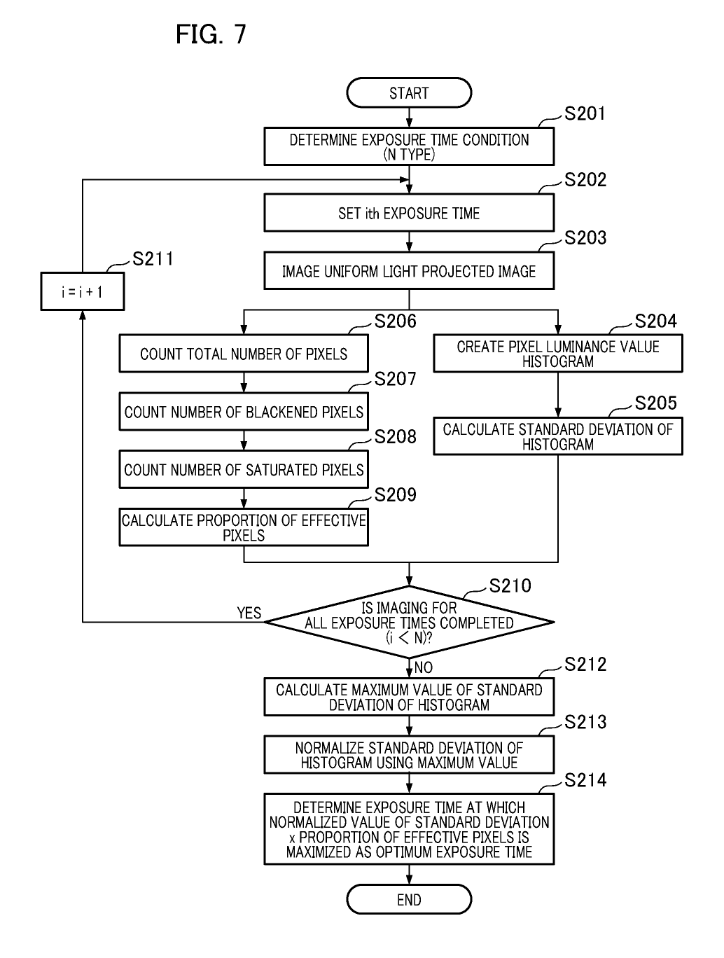

FIG. 7 is a flowchart which shows a process of determining an optimum measurement condition according to the present embodiment. Description of processes that are the same as the processes in FIG. 6 of the first embodiment will be omitted. A process of S201 and a process of S202 are the same as the process of S101 and the process of S102 of FIG. 6, respectively. In the present embodiment, instead of the process of S103 to the process of S105, in a process of S203, the object W onto which uniform light is projected is imaged.

In the processes of S106 and S107, a standard deviation of a histogram created on the basis of luminance of an intersection was calculated. On the other hand, in the present embodiment, a histogram is created on the basis of luminance of pixels constituting a captured image obtained in a process of S203 (a process of S204), and a standard deviation is calculated (a process of S205).

In the process of S108 to the process of S111, a proportion of effective pixels was calculated on the basis of the total number of intersections. In the present embodiment, the total number of pixels constituting the captured image obtained in the process of S203 (a process of S206), the number of pixels in a blackened region (a process of S207), and the number of pixels in a saturated region (a process of S208) are each counted, and a proportion of effective pixels is calculated (a process of S209). A process of S210 and subsequent processes are the same as the process of S112 and subsequent processes.

As described above, even in the grayscale image obtained by projecting uniform light, it is possible to determine an appropriate measurement condition regardless of reflectivity of the surface of the object W, and the present embodiment also has the same effect as the first embodiment.

### (Embodiment of Article Manufacturing Method)

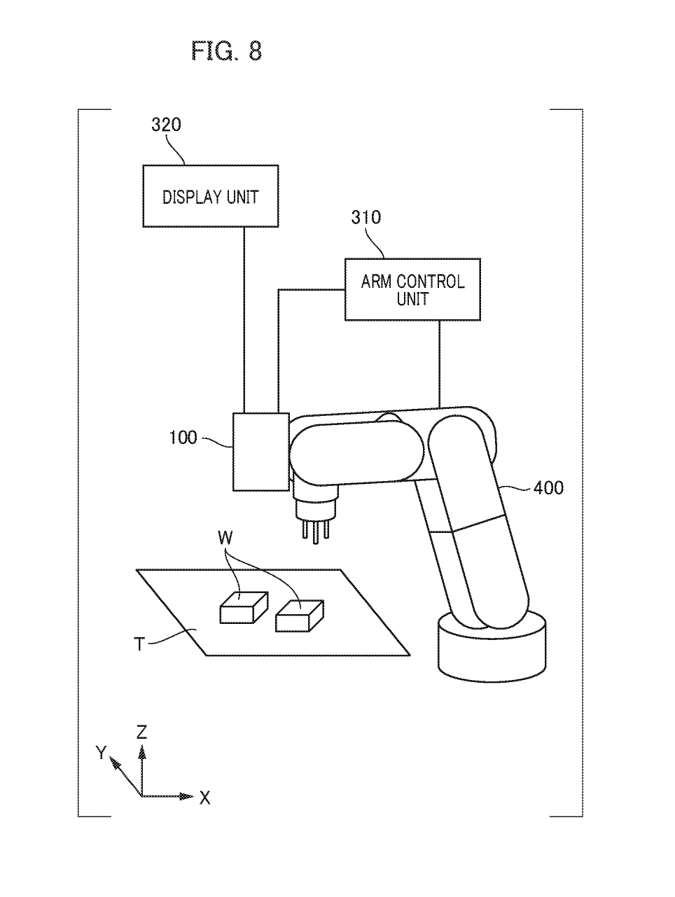

The processing device described above is used in a state in which it is supported by a support member. In the present embodiment, as an example, a control system which is installed in a robot arm 400 (gripping device) and used as shown in FIG. 8 will be described. A processing device 100 performs imaging by projecting pattern light onto the object W placed on a support table T and acquires an image. Then, a control unit (not shown) of the processing device 100 or an arm control unit 310 acquiring image data output from the control unit (not shown) of the processing device 100 obtains a position and a posture of the object W, and the arm control unit 310 acquires information on the obtained position and posture. The arm control unit 310 controls the robot arm 400 by sending a drive instruction to the robot arm 400 on the basis of the information (measurement result) on the position and the posture. The robot arm 400 holds the object W using a robot hand and the like (gripping unit) at the tip, and causes its movement such as translation and rotation. Furthermore, it is possible to manufacture an article constituted by a plurality of parts, such as an electronic circuit board or a machine by installing (assembling) the object W in another part with the robot arm 400. In addition, it is possible to manufacture an article by performing a process (processing) on a moved object W. The arm control unit 310 includes a calculation device such as a CPU and a storage device such as a memory. A control unit for controlling a robot may be provided outside of the control unit 310. In addition, measurement data measured by the processing device 100 or obtained images may also be displayed on a display unit 320 such as a display.

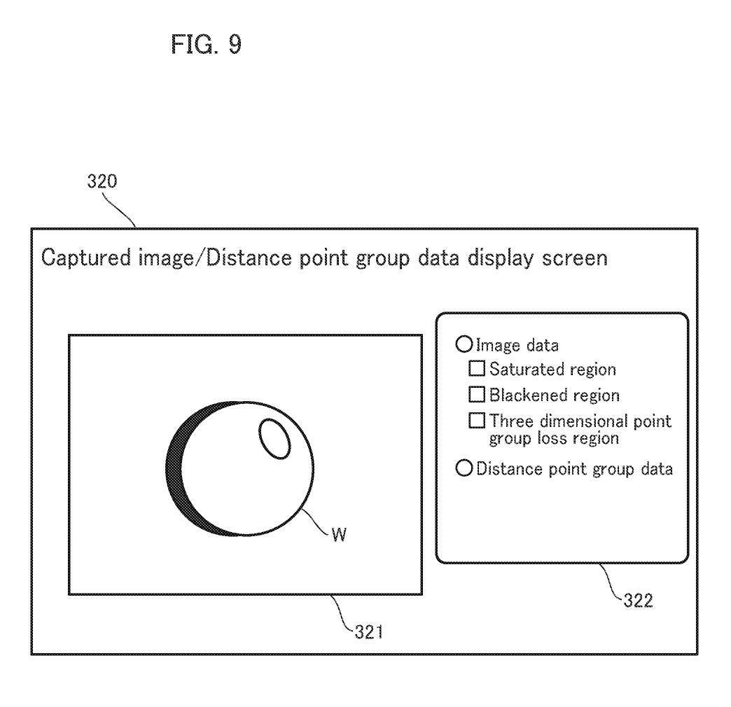

FIG. 9 is a diagram which shows an example of information displayed on the display unit 320. The display unit 320 includes an image display region 321 and a button region 322. In FIG. 9, the object W is set to a sphere with high specular reflectivity. As the display unit 320, various types of display devices such as a liquid crystal display and a plasma display can be used. A captured image or distance point group data captured by the imaging unit of the processing device 100 may be displayed in the image display region 321. Furthermore, a saturated region, a blackened region, and a distance point group loss region may be superimposed and displayed in the captured image. The distance point group loss region indicates a region in which there is an unmeasurable distance point group due to saturated or blackened pixels. A user can determine validity of a set measurement condition on the basis of information displayed in the image display region 321.

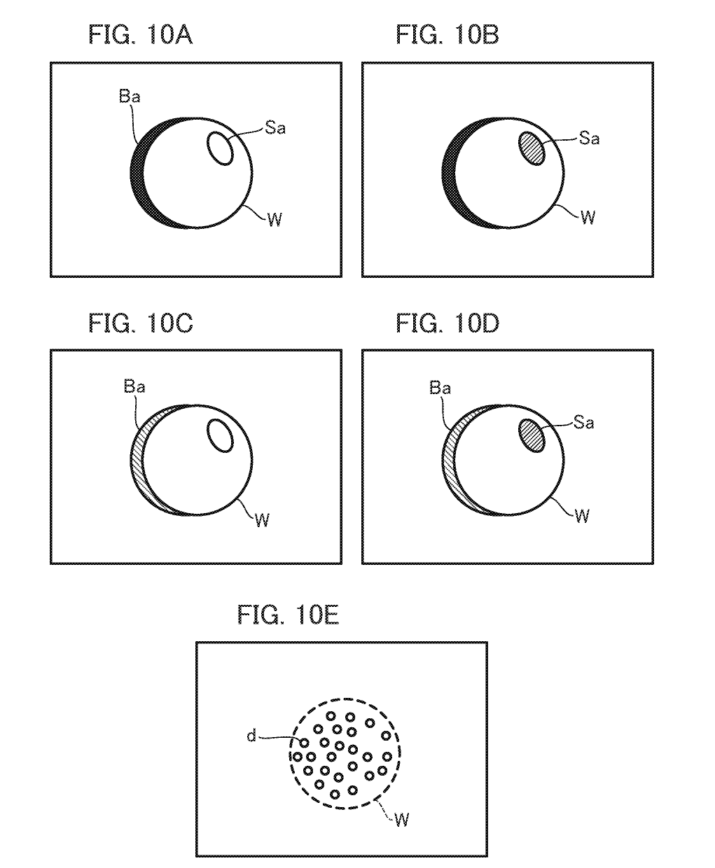

In the button region 322, buttons for selecting a type of image to be displayed in the image display region 321 are disposed. FIGS. 10A to 10E are diagrams which show various types of images displayed in the image display region 321. If a radio button of image data placed in the button region 322 is activated, a captured image shown in FIG. 10A is displayed. A region Ba indicates a shadow region light-shielded by the object W. A region Sa indicates a saturated region in which halation is caused.

If a check box of the saturated region of the button region 322 is activated, the saturated region is highlighted as indicated by diagonal lines in FIG. 10B. If a check box of the blackened region of the button region 322 is activated, the blackened region is highlighted as indicated by diagonal lines in FIG. 10C. If a check box of the distance point group loss region of the button region 322 is activated, a region in which a distance point group cannot be acquired is highlighted as indicated by diagonal lines in FIG. 10D. If a radio button of distance point group data of the button region 322 is activated, distance point group data d is displayed. When the distance point group data is displayed, a three-dimensional viewpoint change may be performed by using an input device such as a mouse or a keyboard.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2017-017601, filed Feb. 2, 2017, which is hereby incorporated by reference wherein in its entirety.

What is claimed is:

1. A processing device including an imaging unit for obtaining image data by imaging an object and a control unit for controlling the imaging unit,
wherein the control unit configured to determine a condition for the imaging on the basis of a magnitude of a luminance distribution corresponding to the image data.

2. The processing device according to claim 1, wherein the control unit configured to determine the condition on the basis of a spread magnitude of luminance value distribution of a plurality of pixels constituting the image data.

3. The processing device according to claim 1, wherein the control unit configured to determine the condition on the basis of a standard deviation of the luminance value distribution.

4. The processing device according to claim 1, wherein the control unit configured to determine the condition on the basis of the number of bins whose frequencies are equal to or greater than a predetermined value among a plurality of bins included in a predetermined luminance value range in a histogram representing the luminance value distribution.

5. The processing device according to claim 1, wherein the control unit configured to determine the condition on the basis of the number of bins whose frequencies are included in a predetermined range among the plurality of bins included in a predetermined luminance value range in the histogram representing the luminance value distribution.

6. The processing device according to claim 1, wherein the control unit configured to determine the condition on the basis of entropy obtained from the luminance value distribution.

7. The processing device according to claim 1, wherein the control unit configured to determine the condition on the basis of a first curved line indicating the magnitude for each of the conditions.

8. The processing device according to claim 6, wherein the control unit configured to determine a condition in which the magnitude is maximized among the conditions in the first curved line.

9. The processing device according to claim 6, wherein the control unit configured to determine the condition on the basis of a second curved line indicating a proportion of pixels included in a predetermined luminance value range for each of the conditions.

10. The processing device according to claim 8, wherein the control unit configured to obtain the condition on the basis of a third curved line obtained by a product of the first curved line and the second curved line.

11. The processing device according to claim 9, wherein the control unit configured to determine a condition in which the third curved line indicates the maximum value among the conditions in the third curved line.

12. The processing device according to claim 1, further comprising:
a projection unit which configured to project pattern light onto the object,
wherein the image data is obtained by the projection unit projecting the pattern light onto the object and the imaging unit imaging the object, and
the control unit configured to extract a plurality of pixels corresponding to the pattern light in the image data and obtains the luminance value distribution for the plurality of pixels.

13. The processing device according to claim 11,
wherein the pattern light including first line pattern light and second line pattern light in which bright and dark portions are inverted from the first line pattern light,
the image data including first image data corresponding to the first line pattern light and second image data corresponding to the second line pattern light, and
the control unit configured to extract pixels in the first image data which have equal luminance values to pixels of the second image data corresponding to the pixels of the first image data as the plurality of pixels.

14. The processing device according to claim 1, wherein the control unit configured to control at least one of a diaphragm and an imaging element included in the imaging unit on the basis of the condition so that the magnitude is within an allowable range.

15. The processing device according to claim 1, further comprising:
a projection unit which configured to project pattern light onto the object,
wherein the control unit configured to control the projection unit on the basis of the condition so that the magnitude is within an allowable range.

16. A system comprising:
a processing device with a function of recognizing an object; and
a robot which configured to hold and move the object recognized by the processing device,
wherein the processing device including an imaging unit which configured to obtain image data by imaging the object and a control unit which configured to control the imaging unit, and
the control unit configured to determine a condition for the imaging on the basis of a magnitude of a luminance distribution corresponding to the image data.

17. A system comprising:
a processing device which including an imaging unit that configured to obtain image data by imaging an object and a control unit that controls the imaging unit; and
a display unit which configured to display image data obtained by the imaging unit according to a condition determined by the control unit,
wherein the control unit configured to determine the condition on the basis of a magnitude of a luminance distribution corresponding to the image data.

18. A processing method of processing image data, the method comprising:
obtaining the image data by imaging an object;
obtaining a spread magnitude of luminance value distribution for a plurality of pixels constituting the image data; and
determining a condition for the imaging on the basis of the magnitude.

19. A method of manufacturing an article, the method including the steps of:
performing a movement of an object recognized using a processing device by a robot;
performing processing of the object moved by the movement; and
manufacturing an article by the processing of the object,
wherein the processing device including an imaging unit that configured to obtain image data by imaging an object and a control unit that configured to control the image unit, and
the control unit configured to determine a condition for the imaging on the basis of a magnitude of a luminance distribution corresponding to the image data.
